(19) United States
(12) Patent Application Publication
(10) Pub. No.: US 2024/0308364 A1
(43) Pub. Date: Sep. 19, 2024

(54) CHARGING CIRCUIT AND METHOD FOR CHARGING AN ELECTRICAL ENERGY STORE, AND ELECTRIC VEHICLE

(71) Applicant: Robert Bosch GmbH, Stuttgart (DE)

(72) Inventors: Bernhard Mader, Kernen (DE); Oliver Blum, Renningen (DE)

(21) Appl. No.: 18/262,353

(22) PCT Filed: Nov. 22, 2021
(86) PCT No.: PCT/EP2021/082447

§ 371 Date: Jul. 20, 2023

(30) Foreign Application Priority Data
Dec. 10, 2020 (DE) 10 2020 215 598.4

(51) Int. Cl. B60L 53/20; B60L 53/62

(52) U.S. Cl. CPC B60L 53/20; B60L 53/62; B60L 2210/10

(57) ABSTRACT

The present invention relates to charging an electrical energy store, in particular a traction battery of an electric vehicle, wherein the electrical energy store has a rated voltage which is higher than an electrical voltage provided for charging. For this purpose, one portion of the electrical energy store is directly charged by the electrical voltage provided, and a further portion of the electrical energy store is charged by means of an electrical voltage which is converted by a DC-DC converter from the voltage provided for charging. In this way, only some of the energy required for charging the electrical energy store has to be converted by means of a voltage converter.

### BACKGROUND

The present invention relates to a charging circuit for charging an electrical energy store as well as an electric vehicle with such a charging circuit. The present invention further relates to a method of charging an electrical energy store.

Fully or at least semi-electrically driven vehicles have at their disposal an electrical energy store, such as a traction battery. This electrical energy store can be charged by an external power source by means of a suitable charging device. The electrical energy is provided in the form of a DC voltage, in particular for high charging power. The DC voltage supplied can hereby correspond to the voltage level of the electrical energy store to be charged. Typical DC voltage charging infrastructures are currently designed to have a maximum final charging voltage of about 500 V. The control of the charging current is usually carried out by the charging infrastructure during the charging process.

Furthermore, there are special cases of electrically operated vehicles with higher battery voltages, for example of 800 V or more. In order to charge such vehicles on a conventional charging infrastructure, the electrical voltage supplied by the charging infrastructure must be converted to the higher voltage level.

Publication DE 10 2017 123 184 A1 describes a device and method for charging an electrical energy store system with a first energy store bank and a second energy store bank. An applied charging voltage corresponds to the rated voltage of the energy store banks. The individual energy store banks are connected in parallel for charging.

### SUMMARY

The present invention discloses a charging circuit and a method for charging an electrical energy store, and an electric vehicle.

Accordingly, the following is provided:

A charging circuit for charging an electrical energy store with an input terminal, a first output terminal and a second output terminal and a DC-DC converter. The input terminal is set up to be connected to an electric DC power source. The first output terminal is set up to be connected to a first portion of the energy store. The second output terminal is set up to be connected to a second portion of the energy store. The DC-DC converter is electrically connected to the input terminal of the charging circuit at an input of the DC-DC converter. Further, the DC-DC converter is electrically connected to the second output terminal of the charging circuit at an output of the DC-DC converter. Moreover, the input terminal of the charging circuit is directly electrically connected to the first output terminal of the charging circuit.

The following is furthermore provided:

An electric vehicle with an electric drive system, an electrical energy store, and a charging circuit according to the present invention for charging the electrical energy store. The electrical energy store comprises a first connection point, a second connection point and a center terminal. A first portion of the electrical energy store is electrically connected to the first connection point and the center terminal. A second portion of the electrical energy store is electrically connected to the second connection point and the center terminal.

Finally, the following is provided:

A method of charging an electrical energy store with a step of directly electrically connecting an input terminal of a charging circuit to a first portion of the electrical energy store. Further, the method comprises a step of converting an electrical voltage at the input terminal of the charging circuit to a further electrical voltage, and a step of providing the further electrical voltage to a second portion of the electrical energy store.

The present invention is based on the recognition that a rated voltage of electrical energy stores in electric vehicles can exceed a maximum charging voltage of conventional charging stations. In order to be able to charge such electrical energy stores at conventional charging stations, a charging circuit must therefore be provided that allows the electrical energy stores to be charged at a high rated voltage. Such charging circuitry as a rule is relatively complex and causes significant costs. In addition, electrical losses are also incurred in a DC voltage conversion, thereby reducing the efficiency of charging the energy store.

It is therefore an idea of the present invention to take this realization into account and enable as simple and efficient charging as possible of electrical energy stores, wherein a DC electrical voltage is used as the charging voltage, the voltage level of which is below the rated voltage of the electrical energy store. For this purpose, it is provided that the electrical voltage supplied by an electrical power source, for example a charging station, is only supplied at a portion of the electrical energy store that corresponds to the charging voltage. In addition, the remaining portion of the electrical energy store is supplied with electrical energy via a DC-DC converter, wherein the DC-DC converter is also supplied with power from the charging station. In this way, the first portion of the electrical energy store can be fed directly from the charging station without further losses being incurred within the charging circuit. Moreover, the DC-DC converter can adjust the electrical charging voltage for the remaining portion of the electrical energy store corresponding to the voltage conditions for charging the electrical energy store. In this way, by the sum of the voltage supplied by the charging station and the further electrical voltage supplied by the DC-DC converter, an electrical voltage which is also suitable for charging electrical energy stores whose final voltage is above the charging voltage from the charging station can be supplied.

However, since only the partial voltage for the second portion of the electrical energy store needs to be converted by means of the DC-DC converter, the electrical losses of the DC-DC converter are less than in a charging circuit in which the charging voltage for the electrical energy store is provided entirely via the DC-DC converter. Thus, the overall efficiency for charging the electrical energy store can be increased.

Further, only a portion of the electrical energy for charging the electrical energy store must be converted by the DC-DC converter in the charging circuit according to the invention. Therefore, the DC-DC converter can be sized correspondingly smaller.

According to one embodiment, a connection point of the first output terminal and a connection point of the second output terminal are electrically connected to each other. This hub formed by the connection point of the first output terminal and the connection point of the second output terminal that are connected to each other can be connected to a center terminal of the electrical energy store. The respective remaining connection points of the two output terminals of the charging circuit can be connected correspondingly to the external terminals of the electrical energy store. Correspondingly, an electrical energy store with a center terminal can be contacted and charged via the charging circuit.

According to one embodiment, the DC-DC converter is set up to galvanically disconnect the input of the DC-DC converter from the output of the DC-DC converter. The galvanic isolation can be carried out, for example, by means of a corresponding converter or the like. In this way, the DC-DC converter provides a potential-free DC electrical voltage at the output.

According to one embodiment, the charging circuit comprises a control device. The control device is set up to control an output voltage and/or an output current of the DC-DC converter. In particular, the control device can adjust the output current and/or the output voltage of the DC-DC converter according to predetermined parameters and/or target values.

According to one embodiment, the control device is set up to adjust the output voltage of the DC-DC converter using an electrical voltage at the first output terminal. For example, a suitable current sensor can be provided on the output terminal or on the input terminal that is electrically connected to the output terminal. In this way, the output voltage of the DC-DC converter can be adjusted corresponding to the voltage ratios at the unregulated first output terminal of the charging circuit.

According to one embodiment, the control device is set up to set an electrical voltage at the output of the DC-DC converter, such that a ratio of the electrical voltage at the output of the DC-DC converter to a target electrical voltage for the second portion of the energy store corresponds to a prespecified ratio of an electrical voltage at the first output terminal to a target electrical voltage for the first portion of the energy store.

According to one embodiment, the control device is set up to adjust the output current of the DC-DC converter using an electrical output current and/or an electrical voltage at the first output terminal. For example, suitable sensors for detecting the electrical current and/or electrical voltage can be provided at the first output terminal.

According to one embodiment, the control device is set up to set an electrical output current at the output of the DC-DC converter, such that a ratio of the output current of the DC-DC converter to a target output current for the second portion of the electrical energy store corresponds to a ratio of the output current at the first output terminal to a target output current for the first portion of the energy store. In this way, electrical charging currents corresponding to one another can be set on the two output terminals of the charging circuit for the corresponding portions of the electrical energy store.

Moreover, the described controls for the electrical voltages and the electrical currents on the output terminals of the charging circuit can also be suitably combined with one another. For example, a constant ratio of the charging voltages can be primarily controlled, wherein a maximum allowable difference in the ratio of the charging currents can be specified as a further condition. Alternatively, the charging currents can also be primarily controlled, wherein a maximum deviation of the voltage ratios can be specified as a further general condition.

### BRIEF DESCRIPTION OF THE DRAWINGS

Further features and advantages of the invention are explained below with reference to the drawings. Shown are:

FIG. 1: a schematic view of a block diagram of a charging circuit for charging an electrical energy store according to one embodiment; and

FIG. 2: a flow diagram as it underlies a method for charging an electrical energy store according to one embodiment.

### DETAILED DESCRIPTION

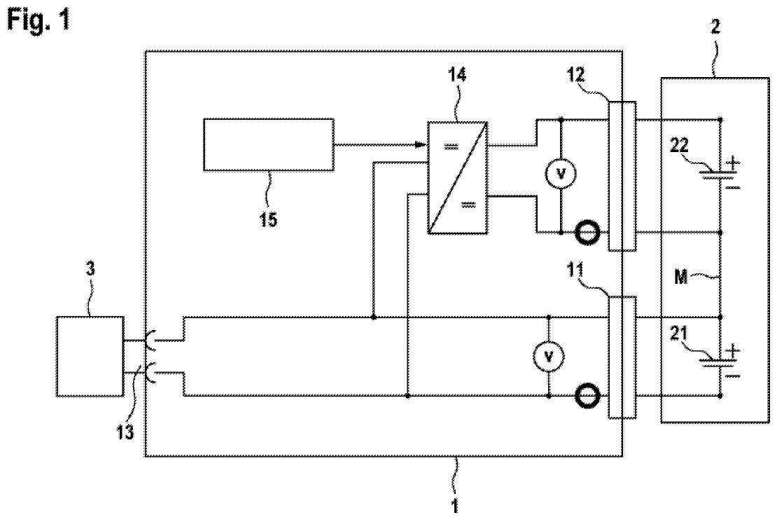

FIG. 1 shows a schematic view of a block diagram of a charging circuit 1 for charging an electrical energy store 2 according to one embodiment. For example, the charging circuit can be supplied with electrical energy from a DC power source, for example a charging station 3. The electrical energy store 2 can in particular be divided into two portions 21 and 22. The two portions 21, 22 of the electrical energy store can be electrically connected to each other via a center terminal M. This center terminal M of the energy store can be fed out as an electrical contact. Thus, the first portion 21 of the electrical energy store 2 provides its electrical energy between a first outer terminal and the center terminal M. The second portion 22 of the electrical energy store 2 provides its electrical energy between the center terminal M and a second outer terminal. Correspondingly, the full voltage of the electrical energy store 2 is applied between the first outer terminal and the second outer terminal.

The charging circuit 1 for charging the electrical energy store 2 comprises an input terminal 13. This input terminal 13 can be connected to the DC power source 3 already mentioned above. A first output terminal 11 of the charging circuit 1 can be electrically connected to the first portion 21 of the electrical energy store 2. A second output terminal 12 of the charging circuit 1 can be connected to the terminals of the second portion 22 of the electrical energy store 2. In other words, the first portion 21 of the electrical energy store 2 is charged via the electrical energy supplied to the first output terminal 11 of the charging circuit 1, and a second portion 22 of the electrical energy store 2 is charged via the electrical energy supplied to the second output terminal 12 of the charging circuit 1.

The first output terminal 11 of the charging circuit 1 is directly electrically connected to the input terminal 13 of the charging circuit 1. Correspondingly, the first output terminal 11 of the charging circuit 1, and thus the first portion 21 of the electrical energy store 2, is fully connected to the electrical voltage supplied by the DC power source 3.

Moreover, the charging circuit 1 comprises a DC-DC converter 14. This DC-DC converter 14 is also connected at its input to the input terminal 13 of the charging circuit 1. The output of the DC-DC converter 14 is electrically connected to the second output terminal 12 of the charging circuit 1 and therefore also to the second portion 22 of the electrical energy store 2. Correspondingly, the second portion 22 of the electrical energy store 2 can be charged with a DC voltage provided by the DC-DC converter 14. The DC-DC converter 14 thereby converts the electrical voltage supplied by the DC power source 3 into an electrical voltage that is suitable for charging the second portion 22 of the electrical energy store 2.

To charge the electrical energy store 2, a DC electrical voltage is thus provided by the DC power source 3, which is suitable for directly charging the first portion 21 of the electrical energy store 2. Moreover, the DC-DC converter 14 of the charging circuit 1 can convert the electrical voltage supplied by the DC power source 3 into a further electrical voltage suitable for charging the second portion 22 of the electric energy store 2. The DC-DC converter 14 can be controlled by a control device 15, for example. For example, the control device 15 can provide suitable control signals, for example pulse width modulated control signals, to the DC-DC converter 14 in order to provide a desired electrical voltage at the output of the DC-DC converter 14.

In particular, if the first portion 21 and the second portion 22 of the electrical energy store 2 are electrically connected to one another at a center terminal M and thus also electrically connected to a connection point of the first output terminal 11 of the charging circuit 1 and a connection point of the second output terminal 12 of the charging circuit 1, it is necessary that the DC-DC converter 14 provides a potential-free output voltage. For this purpose, a galvanic isolation can be provided in the DC-DC converter 14 between the input and the output of the DC-DC converter 14. The galvanic isolation can be carried out, for example, by means of a corresponding converter or the like.

The control device 15 of the charging circuit 1 can adjust the output voltage and/or the output current of the DC-DC converter according to any suitable strategies. For example, a fixed gear ratio, for example a gear ratio of 1:1 can be provided in the DC-DC converter 14. Correspondingly, the output voltage of the DC-DC converter 14 varies analogously to the electrical voltage supplied by the DC power source 3 and is thereby connected to the first output terminal 11 of the charging circuit 1.

Furthermore, for example, the output voltage of the DC-DC converter 14 can be controlled according to any other strategies. For example, the output voltage of the DC-DC converter 14 can be prespecified for controlling the output voltage such that a ratio between the output voltage of the DC-DC converter and the rated voltage of the second portion 22 of the electric energy store 2 corresponds to a ratio between the electrical voltage at the first output terminal 11 of the charging circuit 1 (corresponding to the electrical voltage from the DC power source 3) and the rated voltage for the first portion 21 of the electric energy store 2.

It is also possible to control the DC-DC converter 14 based on specifications for the output currents or charging currents. For example, the DC-DC converter 14 can be controlled such that an electrical output current of the DC-DC converter corresponds to the electrical current with which the first portion 21 of the electrical energy store system is charged. Moreover, any other fixed prespecified ratios between the charging current for the first portion 21 of the electrical energy store 2 and the charging current for the second portion 22 of the electrical energy store 2 are also possible.

Further, the requirements for the charging voltages and charging currents can also be combined with one another in any desired manner. For example, a fixed ratio for the charging currents in the first portion 21 and the second portion 22 of the electrical energy store 2 can be specified as the primary specification. Maximum deviations for the electrical voltages supplied hereby or the ratios between the supplied voltages and rated voltages of the respective portions 21, 22 of the electrical energy store 2 can be specified as a secondary specification. Alternatively, fixed voltages or voltage ratios with respect to the rated voltages of the respective portions 21, 22 of the electrical energy store can also be specified, wherein a maximum deviation of the electrical currents or the ratio of the electrical currents to one another can be specified as secondary framework conditions. Of course, any other specifications for adjusting the electrical voltage and/or the electrical current at the output of the DC-DC converter 14 are also possible.

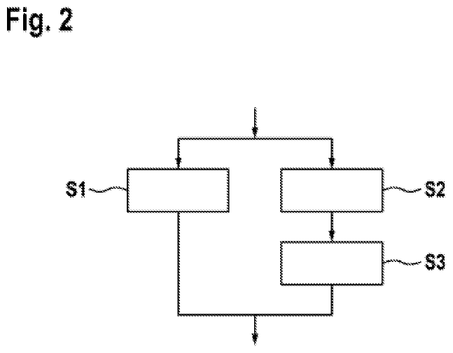

FIG. 2 shows a schematic view of a block diagram of a method for charging an electrical energy store according to one embodiment. The method can generally comprise any desired steps, as already previously described in connection with the device 1 for charging the electrical energy store 2. Analogously, the aforementioned device 1 for charging the electrical energy store 2 can also comprise any components suitable for carrying out the following described method steps.

In step S1, an input terminal 13 of a charging circuit 1 is directly connected to a first portion 21 of an electrical energy store 2. Parallel to this, in step S2, an electrical voltage from the input terminal 13 of the charging circuit 1 is converted to a further electrical voltage and in step S3, the further electrical voltage is supplied at a second portion 22 of the electrical energy store 2.

In summary, the present invention relates to charging an electrical energy store, in particular a traction battery of an electric vehicle, wherein the electrical energy store has a rated voltage that is higher than an electrical voltage provided for charging. For this purpose, one portion of the electrical energy store is directly charged by the electrical voltage provided, and a further portion of the electrical energy store is charged by means of an electrical voltage which is converted by a DC-DC converter from the voltage provided for charging. In this way, only some of the energy required for charging the electrical energy store has to be converted by means of a voltage converter.

1. A charging circuit (1) for charging an electrical energy store (2), the charging circuit comprising:
an input terminal (13) set up to be connected to a DC electric power source (3);
a first output terminal (11) set up to be connected to a first portion (21) of the energy store (2);
a second output terminal (12) set up to be connected to a second portion (22) of the energy store (2); and
a DC-DC converter (14) electrically connected at an input of the DC-DC converter (14) to the input terminal (13) of the charging circuit (1) and electrically connected at an output of the DC-DC converter (14) to the second output terminal (12) of the charging circuit (1);
wherein the input terminal (13) of the charging circuit (1) is electrically directly connected to the first output terminal (11) of the charging circuit (1).

2. The charging circuit (1) according to claim 1, wherein a connection point of the first output terminal (11) and a connection point of the second output terminal (12) are electrically connected to each other.

3. The charging circuit (1) according to claim 1, wherein the DC-DC converter (14) is set up to galvanically isolate the input of the DC-DC converter (14) from the output of the DC-DC converter (14).

4. The charging circuit (1) according to claim 1, with a control device (15) set up to control an output voltage and/or an output current of the DC-DC converter (14).

5. The charging circuit (1) according to claim 4, wherein the control device (15) is set up to adjust the output voltage of the DC-DC converter (14) using an electrical voltage at the first output terminal (11).

6. The charging circuit (1) according to claim 4, wherein the control device (15) is set up to adjust an electrical voltage at the output of the DC-DC converter (14), such that a ratio of the electrical voltage at the output of the DC-DC converter (14) to a target electrical voltage for the second portion (22) of the energy store (2) corresponds to a ratio of an electrical voltage at the first output terminal (11) to a target electrical voltage for the first portion (21) of the energy store (2).

7. The charging circuit (1) according to claim 4, wherein the control device (15) is set up to adjust the output current of the DC-DC converter (14) using an electrical output current and/or an electrical voltage at the first output terminal (11).

8. The charging circuit (1) according to claim 7, wherein the control device (15) is set up to adjust an electrical output current at the output of the DC-DC converter (14) such that a ratio of the output current of the DC-DC converter (14) to a target output current for the second portion (22) of the energy store (2) corresponds to a ratio of output current at the first output terminal (11) to a target output current for the first portion (21) of the energy store (2).

9. An electric vehicle with:
an electrical energy store (2) with a first connection point, a second connection point and a center terminal (M), wherein a first portion (21) of the electrical energy store (2) is electrically connected to the first connection point and the center terminal (M), and a second portion (22) of the electrical energy store (2) is electrically connected to the second connection point and the center terminal (M); and
a charging circuit for charging an electrical energy store according to claim 1.

10. A method of charging an electrical energy store (2), comprising the steps of:
directly electrically connecting (S1) an input terminal (13) of a charging circuit (1) to a first portion (a 20) of the electrical energy store (2);
converting (S2) an electrical voltage at the input terminal (13) of the charging circuit (1) to a further electrical voltage; and
providing (S3) the further electrical voltage at a second portion (22) of the electrical energy store (2).
